(19) United States
(12) Patent Application Publication
(10) Pub. No.: US 2009/0033896 A1
(43) Pub. Date: Feb. 5, 2009

(54) EXPOSURE APPARATUS AND METHOD, AND DEVICE MANUFACTURING METHOD

(76) Inventor: Hiroyuki Nagasaka, Saitama-ken (JP)

Correspondence Address: MILES & STOCKBRIDGE PC, 1751 PINNACLE DRIVE, SUITE 500, MCLEAN, VA, 22102-3833, US

(21) Appl. No.: 11/917,189

(22) PCT Filed: Jun. 27, 2006
(86) PCT No.: PCT/JP2006/312799

§ 371 Date: Dec. 11, 2007

(30) Foreign Application Priority Data
Jun. 28, 2005 (JP) 2005-187889

(51) Int. Cl. G03B 27/42

(52) U.S. Cl. 355/53; 355/77

(57) ABSTRACT

An exposure apparatus (EX) includes: a substrate holder (4H) that holds a substrate (P) onto which exposure light (EL) is irradiated; and a film formation apparatus (60) that forms a film of a liquid (LQ) on the substrate (P) before the substrate (P) is held in the substrate holder (4H).

### TECHNICAL FIELD

The present invention relates to an exposure apparatus and method, and device manufacturing method that expose a substrate via a liquid.

Priority is claimed on Japanese Patent Application No. 2005-187889, filed on Jun. 28, 2005, the contents of which are incorporated herein by reference.

### BACKGROUND ART

In the photolithography process which is one manufacturing process for micro devices (electronic devices etc.) such as semiconductor devices and the like, an exposure apparatus is used which exposes a pattern image of a mask onto a photosensitive substrate. In the manufacture of a micro device, in order to increase the density of the device, it is necessary to make the pattern formed on the substrate fine. In order to address this necessity, even higher resolution of the exposure apparatus is desired. As one means for realizing this higher resolution, there is proposed a liquid immersion exposure apparatus as disclosed in the following patent document, in which a liquid immersion region for a liquid is formed on a substrate, and exposure light is irradiated onto the substrate via the liquid, to thereby expose the substrate.

Patent Document 1: PCT International Publication No. WO 99/49504

### DISCLOSURE OF INVENTION

### Problems to be Solved by the Invention

In liquid immersion exposure apparatuses, use of a liquid with a high refractive index can improve the resolution and the depth of focus. However, there is a possibility that recovery of the liquid from the surface of the substrate is difficult depending on the materiality of the liquid. For example, if the liquid has a high viscosity and a portion of the liquid is left on the substrate after insufficient recovery of the liquid, there is a possibility that the residual liquid prevents the favorable exposure process and/or measurement process.

A purpose of some aspects of the invention is to provide an exposure apparatus and method that can favorably immersion-expose a substrate and to provide a device manufacturing method using the exposure apparatus or the exposure method.

### Means for Solving the Problem

According to a first aspect of the present invention, there is provided an exposure apparatus that exposes a substrate via a liquid, including: a substrate holding member that holds the substrate on which exposure light is irradiated; and a film formation apparatus that forms a film of the liquid before the substrate is held in the substrate holding member.

According to the first aspect of the present invention, a film of the liquid is formed by the film formation apparatus before the substrate is held in the substrate holding member, thereby allowing the substrate to be favorably exposed via the film formed of the liquid.

According to a second aspect of the present invention, there is provided an exposure apparatus that exposes a substrate via a liquid, including: a substrate holding member that holds the substrate on which exposure light is irradiated; and a first transfer apparatus that carries in the substrate, on a surface of which a film of the liquid is formed, to the substrate holding member.

According to the second aspect of the present invention, the substrate with a film of the liquid formed on its surface is carried in to the substrate holding member, thereby allowing the substrate to be favorably exposed via the film.

According to a third aspect of the present invention, there is provided an exposure apparatus that exposes a substrate via a liquid, including: a substrate holding member that holds the substrate, on a surface of which a film of the liquid is formed; and a measurement apparatus that has a first optical member to be contacted with the film of the liquid and directs measurement light onto the substrate via the first optical member and the liquid to perform a measurement related to an exposure process, in which the measurement apparatus directs the measurement light outside an irradiation region, on the substrate, onto which exposure light is irradiated.

According to the third aspect of the present invention, the film of the liquid formed on the surface of the substrate is contacted with the first optical member, and the measurement light is irradiated onto the substrate via the first optical member and the film of the liquid, thereby allowing the measurement light to favorably reach the substrate, and leading to a measurement process with a suitable degree of Furthermore, the measurement light is irradiated outside the irradiation region, on the substrate, onto which the exposure light is irradiated, thereby allowing the measurement process to be favorably performed.

According to a fourth aspect of the present invention, there is provided a device manufacturing method using the exposure apparatus according to the above aspects.

According to the fourth aspect of the present invention, devices can be manufactured using an exposure apparatus that can favorably perform an exposure process and a measurement process.

According to a fifth aspect of the present invention, there is provided an exposure method for exposing a substrate via a liquid, the method including: holding the substrate in a substrate holding member after a film of the liquid is formed on a surface of the substrate and irradiating the substrate with exposure light via the film of the liquid.

According to a sixth aspect of the present invention, there is provided an exposure method for exposing a substrate via a liquid, the method including: holding the substrate, on a surface of which a film of the liquid is formed, in a substrate holding member, bringing a first optical member into contacts with the film of the liquid, and directing measurement light onto the substrate via the first optical member and the liquid to perform measurement related to an exposure process.

According to a seventh aspect of the present invention, there is provided a device manufacturing method using the exposure method according to the above aspects.

### BRIEF DESCRIPTION OF THE DRAWINGS

FIG. 1 is a schematic block diagram showing an exposure apparatus according to a first embodiment.

FIG. 2 shows an example of a film formation apparatus.

FIG. 3 is a diagram for explaining an operation of a transfer apparatus.

FIG. 4 is a perspective view showing an example of a focus leveling detection system.

FIG. 5 is a side sectional view showing an example of a focus leveling detection system.

FIG. 6A is a schematic diagram for explaining a behavior of detection light of a focus leveling detection system.

FIG. 6B is a schematic diagram for explaining a behavior of detection light of a focus leveling detection system.

FIG. 7 is a flow chart for explaining an example of an exposure sequence.

FIG. 8 is a diagram for explaining an operation of a substrate stage.

FIG. 9 is a plan view of a substrate stage holding a substrate, seen from above.

FIG. 10 shows an exposure apparatus according to a second embodiment.

FIG. 11 shows an exposure apparatus according to a third embodiment.

FIG. 12A is a schematic diagram showing another configuration of a focus leveling detection system.

FIG. 12B is a schematic diagram showing another configuration of a focus leveling detection system.

FIG. 12C is a schematic diagram showing another configuration of a focus leveling detection system.

FIG. 12D is a schematic diagram showing another configuration of a focus leveling detection system.

FIG. 13 is a flow chart for explaining an example of manufacturing steps for a micro device.

### BEST MODE FOR CARRYING OUT THE INVENTION

Hereunder is a description of embodiments of the present invention with reference to the drawings. However, the present invention is not limited to this description. In the following description, an XYZ rectangular co-ordinate system is established, and the positional relationship of respective members is described with reference to this XYZ rectangular co-ordinate system. A predetermined direction within a horizontal plane is made the X axis direction, a direction orthogonal to the X axis direction in the horizontal plane is made the Y axis direction, and a direction orthogonal to both the X axis direction and the Y axis direction (that is, a perpendicular direction) is made the Z axis direction. Furthermore, rotation (inclination) directions about the X axis, the Y axis and the Z axis, are made the θX, the θY, and the θZ directions respectively.

### First Embodiment

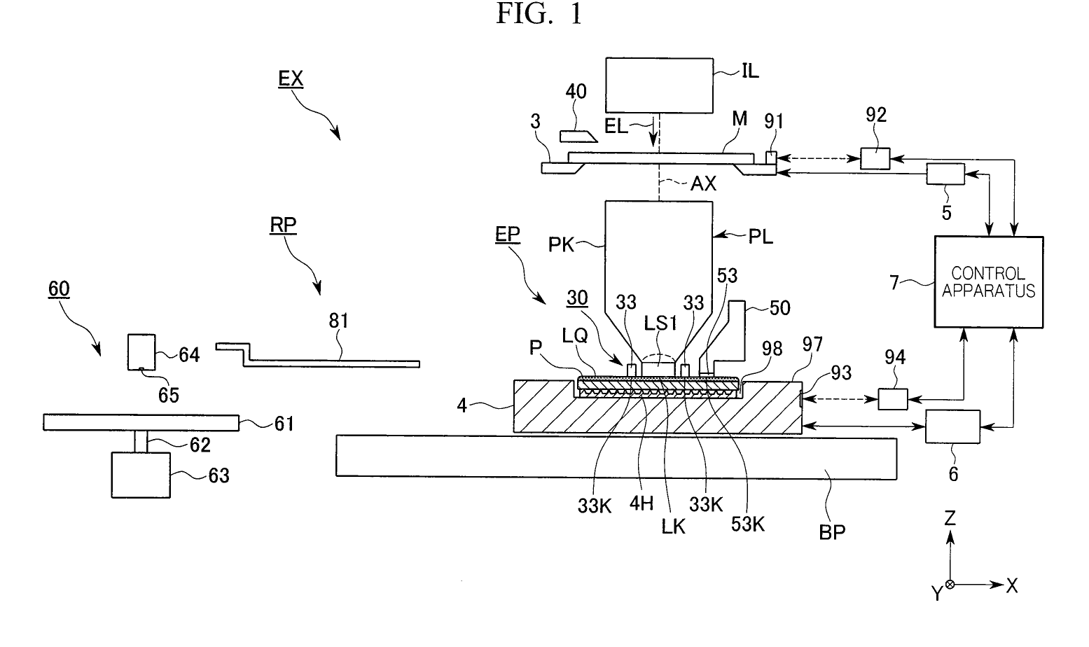

A first embodiment will be described. FIG. 1 is a schematic block diagram showing an exposure apparatus EX according to a first embodiment. In FIG. 1, the exposure apparatus EX comprises: a mask stage 3 capable of holding and moving a mask M, a substrate holder 4H for holding a substrate P, a substrate stage 4 capable of holding and moving the substrate holder 4H, an illumination optical system IL for illuminating a mask M held on the mask stage 3 with exposure light EL, a projection optical system PL for projecting a pattern of the mask M illuminated by the exposure light EL onto the substrate P, and a control apparatus 7 for controlling operation of the whole exposure apparatus EX. The substrate here includes one a sensitive material (photoresist) or a film such as a protection film is spread on a base material such as a semiconductor wafer or the like. The mask includes a reticle formed with a device pattern which is reduction size projected onto the substrate.

The exposure apparatus EX of the present embodiment is an immersion exposure apparatus to which an immersion method is applied for substantially shortening the exposure length and improving the resolution, and also substantially expanding the depth of focus. It irradiates the exposure light EL onto the substrate P via the liquid LQ, to thereby expose the substrate P. The exposure apparatus EX of the present embodiment includes a film formation apparatus 60 for forming a film of the liquid LQ on the substrate P and a transfer apparatus 81 that carries in the substrate P on which the film of the liquid LQ is formed by the film formation apparatus 60 to the substrate holder 4H (substrate stage 4). The exposure apparatus EX illuminates exposure light EL which has passed through the mask M onto the substrate P held on the substrate holder 4H via the projection optical system PL and the film of the liquid LQ formed on the substrate P, to thereby expose the pattern image of the mask M onto the substrate P.

The illumination optical system IL is one which illuminates a predetermined illumination region on the mask M with exposure light EL of a uniform luminance distribution. For the exposure light EL radiated from the illumination optical system IL, for example emission lines (g-line, h-line, i-line), radiated for example from a mercury lamp, deep ultraviolet beams (DUV light beams) such as the KrF excimer laser beam (wavelength: 248 nm), and vacuum ultraviolet light beams (VUV light beams) such as the ArF excimer laser beam (wavelength: 193 nm) and the F₂ laser beam (wavelength: 157 nm), may be used. In the present embodiment, the ArF excimer laser beam is used.

The mask stage 3 is movable in the X axis, the Y axis, and the OZ direction in a condition holding the mask M, by means of drive from a mask stage driving unit 5 which includes an actuator such as a linear motor. Position information of the mask stage 3 (and consequently the mask M) is measured by a laser interferometer 92. The laser interferometer 92 uses a movement mirror 91 which is provided on the mask stage 3 to measure the position information of the mask stage 3. The control apparatus 7 controls the mask stage driving unit 5 based on the measured results of the laser interferometer 92, and controls the position of the mask M which is held on the mask stage 3.

The movement mirror 91 may include not only a plane mirror, but also a corner cube (retroreflector), and instead of securing the movement mirror 91 to the mask stage 3, a mirror surface may be used which is formed by mirror polishing for example the end face (side face) of the mask stage 3. Furthermore, the mask stage 3 may be of a construction capable of course/fine movement as disclosed for example in Japanese Unexamined Patent Application, First Publication No. H08-130179 (corresponding to U.S. Pat. No. 6,721,034).

The projection optical system PL is one which projects a pattern image of the mask M onto the substrate P at a predetermined projection magnification, and has a plurality of optical elements, and these optical elements are held in a lens barrel PK. The optical axis AX of the projection optical system PL is parallel with the Z axis direction. The projection optical system PL of the present embodiment is a reduction system with a projection magnification of for example ¼, ⅕, ⅛ or the like. The projection optical system PL may be a reduction system, an equal system or a magnification system. Furthermore, the projection optical system PL may include any one of: a refractive system which does not include a reflection optical element, a reflection system which does not include a refractive optical element, or a cata-dioptric system which includes a reflection optical system and a refractive optical system. Moreover, the projection optical system PL may form either an inverted image or an erect image. Furthermore, in the present embodiment, of the plurality of optical elements of the projection optical system PL, only the final optical element LS1 which is closest to the image plane of the projection optical system PL contacts the film of the liquid LQ formed on the substrate P.

The substrate stage 4 has a substrate holder 4H for holding the substrate P, and is capable of holding the substrate P held in the substrate holder 4H and moving above a base member BP. The substrate holder 4H is arranged in a recess portion 98 which is provided in the substrate stage 4, and an upper surface 97 of the substrate stage 4 other than the recess portion 98 becomes a flat surface of approximately the same height (flush) as the surface of the substrate P which is held in the substrate holder 4H. Note that there may be a step between the surface of the substrate P which is held in the substrate holder 4H, and the upper surface 97 of the substrate stage 4. Moreover, only one part of the upper surface 97 of the substrate stage 4, for example, a predetermined region surrounding the substrate P, may be approximately the same height as the surface of the substrate P. Furthermore, the substrate holder 4H may be formed as one with one part of the substrate stage 4. However, in the present embodiment, the substrate holder 4H and the substrate stage 4 are made separate, and the substrate holder 4H is secured in the recess portion 98 by, for example, vacuum attraction.

The substrate stage 4 is movable in a direction of six degrees of freedom of: the X axis, the Y axis, the Z axis, the θX, the θY and the θZ directions, in a condition with the substrate P held, by means of drive from a substrate stage driving unit 6 which includes an actuator such as a linear motor. Position information of the substrate stage 4 (and consequently the substrate P) is measured by a laser interferometer 94. The laser interferometer 94 uses a movement mirror 93 which is provided on the substrate stage 4 to measure the position information of the substrate stage 4 in relation to the X axis, the Y axis, and the θZ directions. Furthermore, surface position information of the surface of the substrate P held in the substrate stage 4 (position information related to the Z axis, the θX, and the θY directions) is detected by a focus leveling detection system 30, which will later be described in detail. The control apparatus 7 drives the substrate stage driving unit 6 based on the detection results of the laser interferometer 94, and the detection results of the focus leveling detection system 30, to control the position of the substrate P which is held in the substrate stage 4 (substrate holder 4H).

The laser interferometer 94 may also be capable of measuring the position in the Z axis direction of the substrate stage 4, and the rotation information in the OX and the θY directions. More detail of this is disclosed for example in Japanese Unexamined Patent Application, First Publication No. 2001-510577 (corresponding to PCT International Publication No. WO 1999/28790). Furthermore, instead of fixing the movement mirror 93 to the substrate stage 4, a reflection surface may be used where for example a part of the substrate stage 4 (the side face or the like) is formed by a mirror polishing process.

In the vicinity of the mask stage 3, there is provided a mask alignment system 40 including a TTR type alignment system that uses light with an exposure wavelength for simultaneously observing an alignment mark on the mask M and a reference mark (first reference mark) on a reference mark plate provided on the substrate stage 4 via the projection optical system PL. The mask alignment system 40 simultaneously observes the alignment mark on the mask M and the corresponding first reference mark on the reference mark plate. The mask alignment system 40 of the present embodiment adopts the VRA (Visual Reticle Alignment) system as disclosed in, for example, Japanese Unexamined Patent Application, First Publication No. H07-176468 (corresponding to U.S. Pat. No. 5,646,413), in which light is irradiated onto the mark and the image data of the mark taken with a CCD camera or the like is subjected to image processing to detect the mark position.

In the vicinity of the front end of the projection optical system PL, there is provided an off-axis type alignment system 50 for detecting an alignment mark on the substrate P, a reference mark (second reference mark) on the reference mark plate provided on the substrate stage 4, and the like. The alignment system 50 of the present embodiment adopts the FIA (Field Image Alignment) system as disclosed in, for example, Japanese Unexamined Patent Application, First Publication No. H04-65603 (corresponding to U.S. Pat. No. 5,995,234), in which broadband detection light that does not expose a photosensitive material on the substrate P is irradiated on a target mark, and the image of the target mark formed on the light receiving surface by the reflection light from the target mark and the image of an index (not shown in the figure) (index pattern on an index plate provided in the alignment system 50) are taken with an image pickup device (CCD or the like), and the image pickup signals are subjected to image processing to measure the mark position.

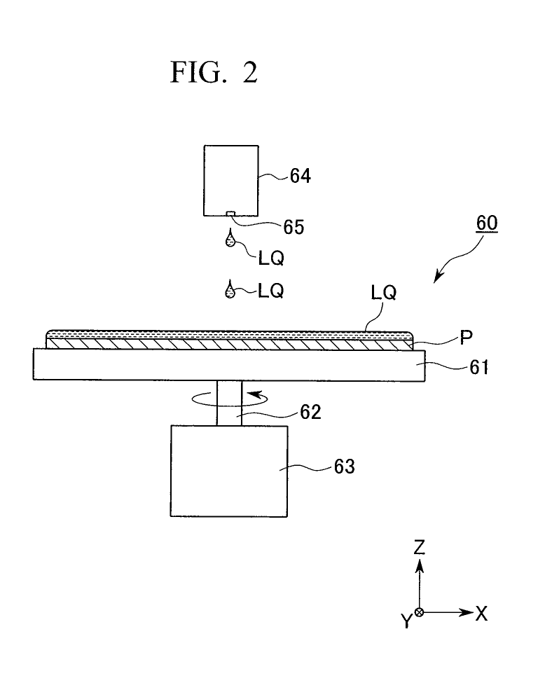

Next is a description of a film formation apparatus 60 with reference to FIG. 2. The film formation apparatus 60 forms a film of the liquid LQ on the substrate P before the substrate P is held in the substrate holder 4H. In FIG. 2, the film formation apparatus 60 includes: a holder 61 for holding the substrate P; a support member 62 for rotatably supporting the holder 61; a driving unit 63 for rotating the holder 61 holding the substrate P by rotating the support member 62; and the nozzle member 64, provided at a position that faces the substrate P held on the holder 61, that has a supply port 65 for supplying the liquid LQ onto the substrate P. The film formation apparatus 60, while using the driving unit 63 to rotate the substrate P held on the holder 61, supplies the liquid LQ from the nozzle member 64 to the substrate P, to thereby form a film of the liquid LQ on the substrate P. That is, the film formation apparatus 60 of the present embodiment forms a film of the liquid LQ on the substrate P by the so-called spin coating method. Note that another method (for example, a scan coating method) may be adopted as long as a film of the liquid LQ can be formed on the substrate P.

Next is a description of the liquid LQ. In the following description, the refractive index of the liquid LQ or the final optical element LS1 with respect to the exposure light EL (ArF excimer laser light) is simply described as the refractive index. In the present embodiment, as the liquid LQ, a liquid is used which can transmit the exposure light EL (ArF excimer laser light) and additionally has a refractive index substantially equal to or higher than that of the final optical element LS1. In the present embodiment, the final optical element LS1 is formed of quartz, which has a refractive index of approximately 1.5. On the other hand, the liquid LQ of the present embodiment has a refractive index of approximately 1.5 to 1.8. Note that the final optical element LS1 may be formed of fluorite. In the present embodiment, a liquid LQ with a high refractive index is used. Therefore, the resolution and the depth of focus can be significantly improved.

If the liquid LQ has a predetermined viscosity, the surface of the substrate P can be favorably covered with the liquid LQ, and thus, the substrate P can be smoothly transferred by the transfer apparatus 81 with the film of the liquid LQ formed on the surface of the substrate P. For example, water at room temperature has a viscosity of approximately 1.0×10⁻³ [Pa·s]. By use of a liquid LQ with a viscosity higher than this, the surface of the substrate P can be favorably covered with the liquid LQ. Even when the substrate P is transferred by the transfer apparatus 81 with the film of the liquid LQ formed on the surface of the substrate P, flowing out of the liquid LQ from the substrate P can be suppressed. For example, glycerol may be used as the liquid LQ. Glycerol at 20° C. has a viscosity of approximately 1.5 [Pa·s].

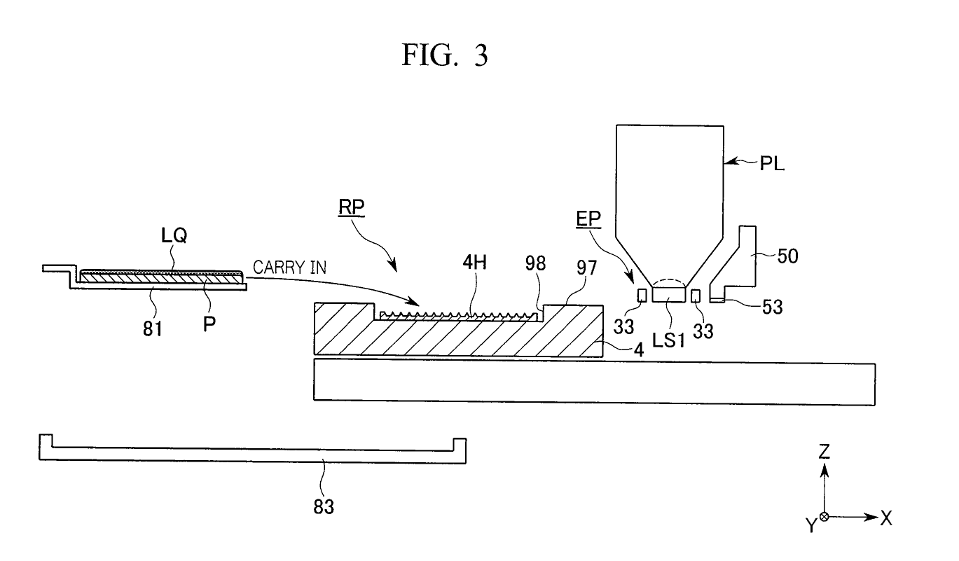

FIG. 3 is a drawing for explaining an operation of the transfer apparatus 81. The transfer apparatus 81 is for carrying in (loading) the substrate with a film of the liquid LQ formed on the surface thereof to the substrate holder 4H. The transfer apparatus 81 receives the substrate P, on which the film of the liquid LQ is formed by the film formation apparatus 60, from the film formation apparatus 60 and carries it in the substrate holder 4H. Here, the substrate stage 4 is movable between an exposure process position EP and a substrate exchange position RP. The exposure process position EP is a position at which the exposure light EL can be irradiated onto the substrate P held in the substrate holder 4H, more specifically a position that faces the final optical element LS1 of the projection optical system PL. The substrate exchange position (loading position) RP is established at a position away from the projection optical system PL. It is a position where carry-in (load) and carry-out (unload) of the substrate P to and from the substrate stage 4 (substrate holder 4H) are performed. When carrying in the substrate P to the substrate holder 4H by the transfer apparatus 81, the control apparatus 7 moves the substrate stage 4 to the substrate exchange position RP. Then, at the substrate exchange position RP, the control apparatus 7 carries in the substrate P to the substrate holder 4H of the substrate stage 4 by means of the transfer apparatus 81. Loading of the substrate P and unloading of the substrate P may be performed at different positions. Moreover, in the present embodiment, along the transfer pathway of the transfer system including the transfer apparatus 81, there is provided a recovery mechanism 83 for recovering the liquid that has flowed out from the surface of the substrate P.

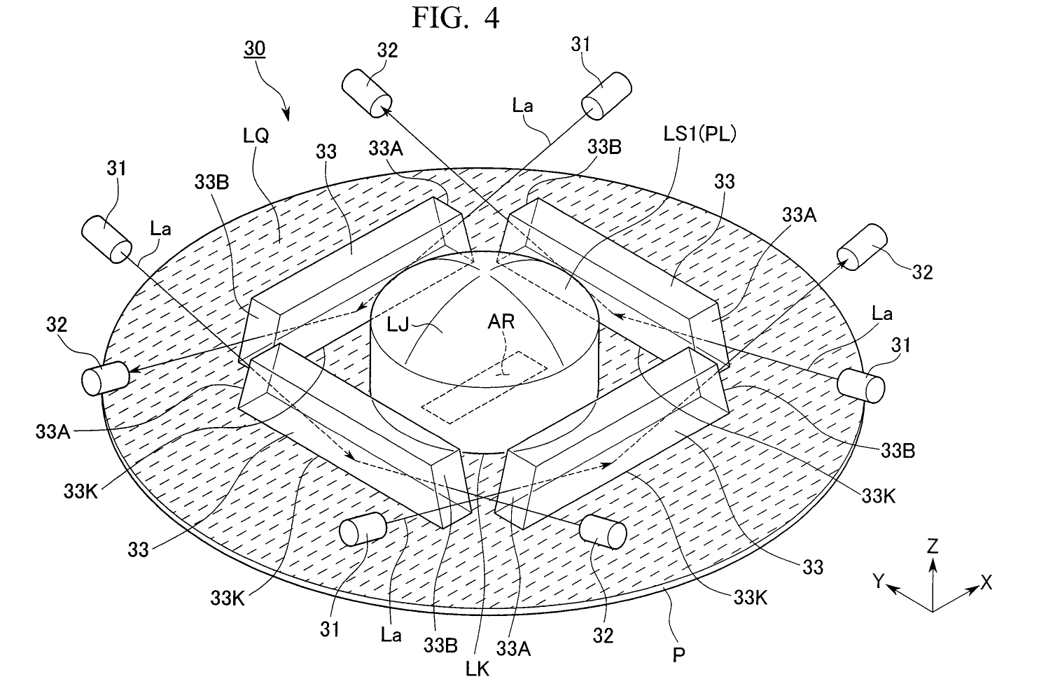

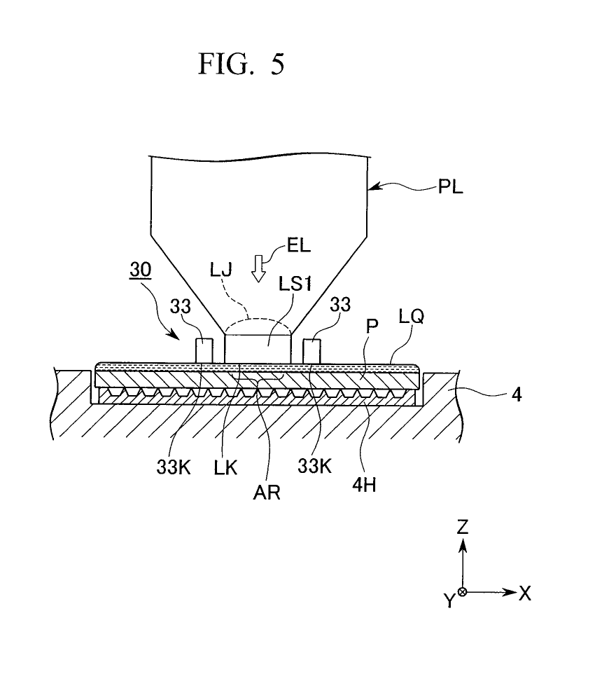

Next is a description of a focus leveling detection system 30 that measures surface position information of the substrate P, with reference to FIG. 4 and FIG. 5. FIG. 4 is a perspective view showing the main part of the focus leveling detection system 30. FIG. 5 is a side sectional view thereof. The focus leveling detection system 30 includes: optical members 33 that are contacted with the film of the liquid LQ formed on the substrate P held in the substrate holder 4H; projection systems 31 that irradiate detection light La onto the substrate P via the respective optical member 33 and the liquid LQ; and light receiving systems 32 that are capable of receiving the detection light La emitted from the respective projection systems 31 and reflected on the substrate P. The plurality of optical members 33 are provided so as to surround the final optical element LS1 through which the exposure light EL passes. That is, the optical members 33 are arranged outside the irradiation region AR, on the substrate P, onto which the exposure light EL is irradiated. The irradiation region AR is a projection region of the projection optical system PL that is conjugate with the aforementioned illumination region. The plurality of projection systems 31 and plurality of the light receiving systems 32 are provided so as to correspond to the respective optical members 33.

In the present embodiment, four optical members 33 are provided outside the projection region (illumination region). More specifically, the optical members 33 are arranged respectively on the +X side, —X side, +Y side, and —Y side of the projection region AR (the final optical element LS1). Four projection systems 31 and four light receiving systems 32 are respectively provided so as to correspond to each of the four optical members 33.

Each of the optical members 33 is made of a prism member, and is capable of transmitting the detection light La emitted from the projection system 31. Each of the optical members 33 has a bottom surface 33K that faces and is substantially parallel with the surface of the substrate P. The bottom surface 33K of the optical member 33 is substantially flat. Here, the substrate holder 4H holds the substrate P so that the surface of the substrate P is substantially parallel with the XY plane, and hence the bottom surface 33K of the optical member 33 is a plane substantially parallel with the XY plane. When irradiating the detection light La onto the substrate P, the control apparatus 7 brings the bottom surface 33K of the optical member 33 into contact with the film of the liquid LQ formed on the substrate P. Note that the bottom surface 33K of the optical member 33 may be curved.

The final optical element LS1 has a bottom surface LK that faces the surface of the substrate P arranged right under the projection optical system PL. The bottom surface LK is substantially parallel with the surface of the substrate P (the XY plane). In the present embodiment, the bottom surface LK of the final optical element LS1 is substantially flat. When irradiating the exposure light EL onto the substrate P, the control apparatus 7 brings the bottom surface LK of the final optical element LS1 in contact with the film of the liquid LQ formed on the substrate P. On the other hand, an upper surface LJ of the final optical element LS1 has a protrusion region so as to swell toward the mask M side (the object side of the projection optical system PL). The protrusion region of the upper surface LJ is curved. Note that the shapes of the upper surface LJ and bottom surface LK of the final optical element LS1 are appropriately determined so that the projection optical system PL will obtain the desired performance. For example, the upper surface LJ of the final optical element LS1 may be of spherical shape or aspherical shape.

In the present embodiment, the bottom surfaces 33K of the optical members 33 and the bottom surface LK of the final optical element LS1 are provided at substantially the same position (height) with regard to the Z axis direction. This allows the bottom surfaces 33K of the optical members 33 and the bottom surface LK of the final optical element LS1 to be simultaneously contacted with the film of the liquid LQ on the substrate P. The bottom surfaces 33K of the optical members 33 and the bottom surface LK of the final optical element LS1 may be provided at different positions (heights) with regard to the Z axis direction as long as the bottom surfaces 33K of the optical members 33 and the bottom surface LK of the final optical element LS1 can be simultaneously contacted with the film of the liquid LQ on the substrate P.

Each of the optical members 33 has a first side surface 33A arranged at a predetermined position with respect to the projection system 31 and a second side surface 33B arranged at a predetermined position with respect to the light receiving system 32. The detection light La emitted from the projection system 31 is irradiated onto the first side surface 33A. The detection light La that has been irradiated onto the first side surface 33A passes through the optical member 33, and then is emitted from the bottom surface 33K. Since the bottom surface 33K of the optical member 33 is in contact with the film of the liquid LQ on the substrate P, the detection light La that has been emitted from the bottom surface 33K is incident into the liquid LQ without passing through a gas portion. The detection light La that has been incident into the liquid LQ is obliquely incident on the surface of the substrate P and is reflected by the surface of the substrate P. The optical member 33 including the bottom surface 33K is provided outside the projection region AR, and hence the detection light La is irradiated outside the projection region AR. The detection light La that has been reflected by the surface of the substrate P passes through the liquid LQ, and then is incident into the optical member 33 from the bottom surface 33K of the optical member 33. Since the bottom surface 33K of the optical member 33 is in contact with the film of the liquid LQ on the substrate P, the detection light La that has been reflected by the surface of the substrate P is obliquely incident into the bottom surface 33K of the optical member 33 without passing through a gas portion. The detection light La that has been incident into the bottom surface 33K and passed through the optical member 33 is emitted from the optical member 33 via the second side surface 33B. The detection light La that has been emitted from the second side surface 33B of the optical member 33 is received at the light receiving system 32. The focus leveling detection system 30 is capable of detecting surface position information of the substrate P held in the substrate holder 4H, more specifically, position information of the surface of the substrate P in the Z axis direction based on the light reception result of the light receiving system 32. Moreover, the focus leveling detection system 30 is capable of detecting the position information of the substrate P held in the substrate holder 4H in the θX direction and the θY direction (inclination direction) based on the light reception results of the plurality of light receiving systems 32. Furthermore, when a plurality of detection lights La are emitted from one projection system 31 onto the substrate P and the plurality of detection lights La that have been reflected on the substrate P are received at the light receiving system 32, the focus leveling detection system 30 is capable of detecting the position information of the substrate P held in the substrate holder 4H in the θX direction and the θY direction (inclination direction) based on the light reception result of the light receiving system 32.

In this manner, the focus leveling detection system 30 directs via the optical member 33 and the liquid LQ the detection light La outside the projection region AR, on the substrate, onto which the exposure light EL is irradiated, to thereby detect the surface position information of the substrate P. Furthermore, the focus leveling detection system 30 has the optical member 33 with the bottom surface 33K that contacts the liquid LQ formed on the substrate P. It is configured so as to direct the detection light La onto the surface of the substrate P in the state with the liquid LQ in close contact with the bottom surface 33K of the optical member 33. That is, it is configured such that the detection light La is incident into the liquid LQ via the interface formed by the liquid LQ and the bottom surface 33K of the optical member 33. Therefore, the detection light La that has been emitted from the projection system 31 and passed through the optical member 33 is capable of reaching the surface of the substrate P via the liquid LQ without passing through a gas portion.

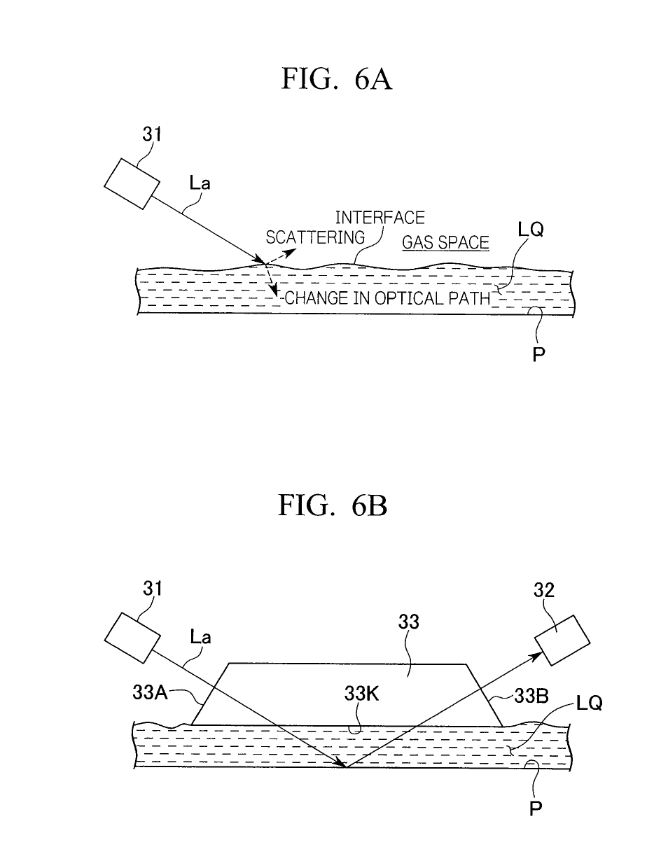

The condition (such as the shape) of the interface formed by a liquid and a gas is very likely to change. Therefore, in the case where the detection light La is incident into the liquid LQ via the interface formed by the liquid LQ and a gas as shown in the schematic diagram of FIG. 6A, the optical path of the detection light La may be changed at the interface, or the detection light La may be scattered or shimmered at the interface. In that case, there is a possibility that an unfavorable situation may occur in that the detection light La cannot favorably reach the surface of the substrate P. In the present embodiment, as shown in the schematic diagram of FIG. 6B, the bottom surface 33K of the optical member 33 contacts the film of the liquid LQ on the substrate P. Consequently, the detection light La that has been emitted from the projection system 31 and passed through the optical member 33 is irradiated onto the surface of the substrate P without passing through a gas portion, that is, without passing through the interface formed by the liquid and the gas. Therefore, the detection light La that has been emitted from the projection system 31 is capable of favorably reaching the surface of the substrate P via the optical member 33 and the liquid LQ without the occurrence of an unfavorable situation such as the detection light La having its optical path changed or is scattered. Similarly, since the liquid LQ is in close contact with the bottom surface 33K of the optical member 33, the detection light La that has been irradiated onto and reflected by the surface of the substrate P is capable of being incident into the bottom surface 33K of the optical member 33 via the liquid LQ without passing through a gas portion, that is, without passing through the interface formed by the liquid and the gas. Therefore, the detection light La that has been reflected on the surface of the substrate P is capable of favorably reaching the light receiving system 32 via the liquid LQ and the optical member 33 without the occurrence of an unfavorable situation such as the detection light La having its optical path changed or being scattered.

Furthermore, the focus leveling detection system 30 is configured so as to irradiate the detection light La outside the projection region AR on the substrate P via the optical member 33 and the liquid LQ. Therefore, the detection light La can be smoothly irradiated onto the surface of the substrate P. That is, depending on the configuration of the projection optical system PL or on the arrangement of the peripheral members, it may be difficult for the detection light La to be irradiated onto a region, on the surface of the substrate P, that faces the final optical element LS1 or onto the projection region AR on the substrate P. However, in the present embodiment, the detection light La is irradiated outside the projection region AR on the substrate P. Therefore, the detection light La can be smoothly irradiated while providing more freedom of arrangement of the members that constitute the exposure apparatus EX.

Furthermore, as shown in FIG. 1 or the like, there is provided an optical member 53 at a position in the alignment system 50 that allows contact with the film of the liquid LQ formed on the substrate P. The optical member 53 faces the surface of the substrate P, and has a bottom surface 53K that is substantially parallel with the surface of the substrate P. The optical member 53 of the alignment system 50 is provided at a position away from the final optical element LS1 of the projection optical system PL and the optical members 33 of the focus leveling detection system 30, that is, at a position outside the projection region AR of the projection optical system PL. When using the alignment system 50 to irradiate the detection light onto a target mark (an alignment mark on the substrate P, a reference mark on the reference mark plate) for detecting the target mark, the control apparatus 7 brings the optical member 53 into contact with the liquid LQ. The alignment system 50 irradiates the detection light onto the target mark arranged outside the projection region AR via the optical member 53 and the liquid LQ to measure the target mark. In the present embodiment, the bottom surface 53K of the optical member 53 is provided at substantially the same position (height) as the bottom surfaces 33K of the optical members 33 and/or the bottom surface LK of the final optical element LS1 with respect to the Z axis direction. However, the bottom surface 53K may be provided at a position different from the bottom surfaces 33K and/or the bottom surface LK.

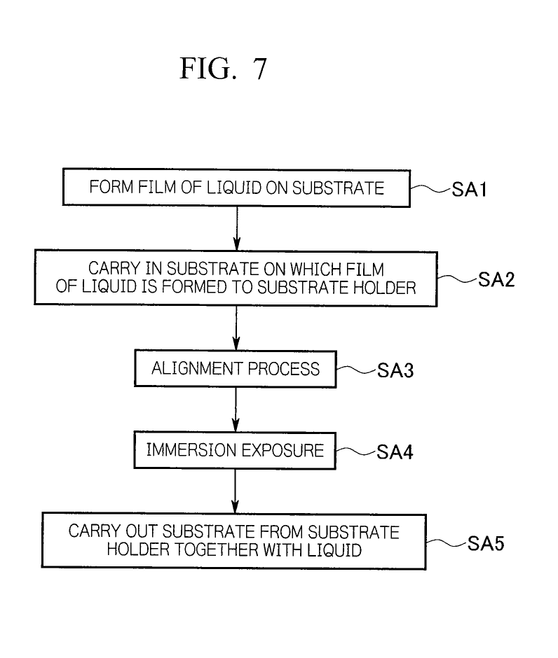

Next is a description of a method for exposing the substrate P using the exposure apparatus EX with the aforementioned configuration, with reference to the flow chart of FIG. 7.

First, the substrate P is transferred by the transfer apparatus (not shown in the figures) from a processing apparatus different from the exposure apparatus EX to the film formation apparatus 60. This processing apparatus includes a coating apparatus (coater/developer apparatus) for spreading a photosensitive material on the base material such as a semiconductor wafer. The substrate P including the photosensitive material is carried in to the holder 61 of the film formation apparatus 60 by the transfer apparatus (not shown in the figures). The film formation apparatus 60 forms a film of the liquid LQ on the surface of the substrate P that has been carried in from the coating apparatus and held in the holder 61 (Step SA1). In the present embodiment, as shown in FIG. 2 and the like, the film of the liquid LQ is formed over the entire region on the surface of the substrate P.

After using the film formation apparatus 60 to form the film of the liquid LQ on the surface of the substrate P, the control apparatus 7 uses the transfer apparatus 81 to carry in the substrate P on the surface of which the film of the liquid LQ is formed to the substrate holder 4H of the substrate stage 4 (Step SA2). The film formation apparatus 60 of the present embodiment can be provided anywhere along the transfer pathway of the transfer system including the transfer apparatus 81 that transfers the substrate P.

As described with reference to FIG. 3, when using the transfer apparatus 81 to carry in (load) the substrate P to the substrate holder 4H, the control apparatus 7 moves the substrate stage 4 to the substrate exchange position RP. The transfer apparatus 81 carries in the substrate P to the substrate holder 4H at the substrate exchange position RP.

The liquid LQ of the present embodiment has a high viscosity. Therefore, even while the transfer apparatus 81 is used to transfer the substrate P, the condition of the film of the liquid LQ formed on the substrate P is maintained. Moreover, even if the liquid LQ is flowed out from the surface of the substrate P during the transfer of the substrate P by the transfer apparatus 81, the leaked liquid LQ can be recovered by a liquid recovery mechanism 83, which is provided along the transfer pathway of transfer of the transfer system including the transfer apparatus 81. Therefore, an unfavorable situation such as the liquid LQ that has flowed out from the surface of the substrate P being scattered can be prevented.

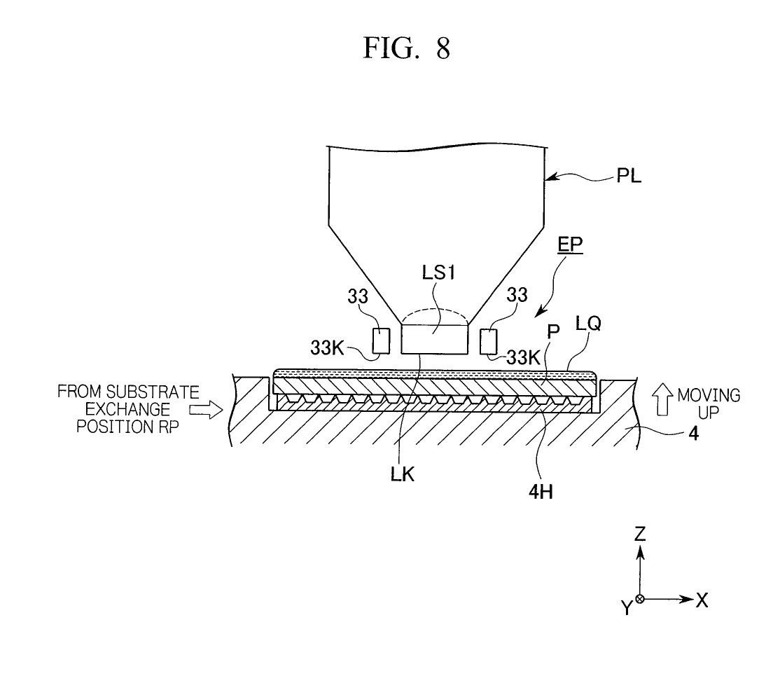

After carrying in the substrate P to the substrate holder 4H on the substrate stage 4 at the substrate exchange position RP, the control apparatus 7 moves the substrate stage 4 within the XY plane from the substrate exchange position RP to the exposure process position EP. When moving the substrate stage 4 to the exposure process position EP, the control apparatus 7 allows the substrate P to face the final optical element LS1 in the state with the film of the liquid LQ on the substrate P spaced away from the final optical element LS1, as shown in FIG. 8. The control apparatus 7 then moves (raises) the substrate stage 4 in the +Z direction from the state shown in FIG. 8, to thereby bring the film of the liquid LQ on the substrate P into contact with the bottom surface LK of the final optical element LS1 and the bottom surfaces 33K of the optical members 33 of the focus leveling detection system 30. As described above, the bottom surface LK of the final optical element LS1 and the bottom surfaces 33K of the optical members 33 are set in such a positional relationship as to allow simultaneous contact with the film of the liquid LQ on the substrate P.

When the film of the liquid LQ on the substrate P contacts the bottom surfaces 33K of the optical members 33, the substrate stage 4 may be moved in the XY direction along with the movement in the +Z direction. Furthermore, the position of the substrate P in the Z direction may be adjusted until just before the substrate P advances under the optical members 33, and the film of the liquid LQ on the substrate P may be placed into contact with the bottom surfaces 33K of the optical members 33 when the substrate P has advanced under the optical members 33.

Next, the control apparatus 7 uses the alignment system 50 to perform an alignment process including a measurement operation of the alignment mark on the substrate P (Step SA3).

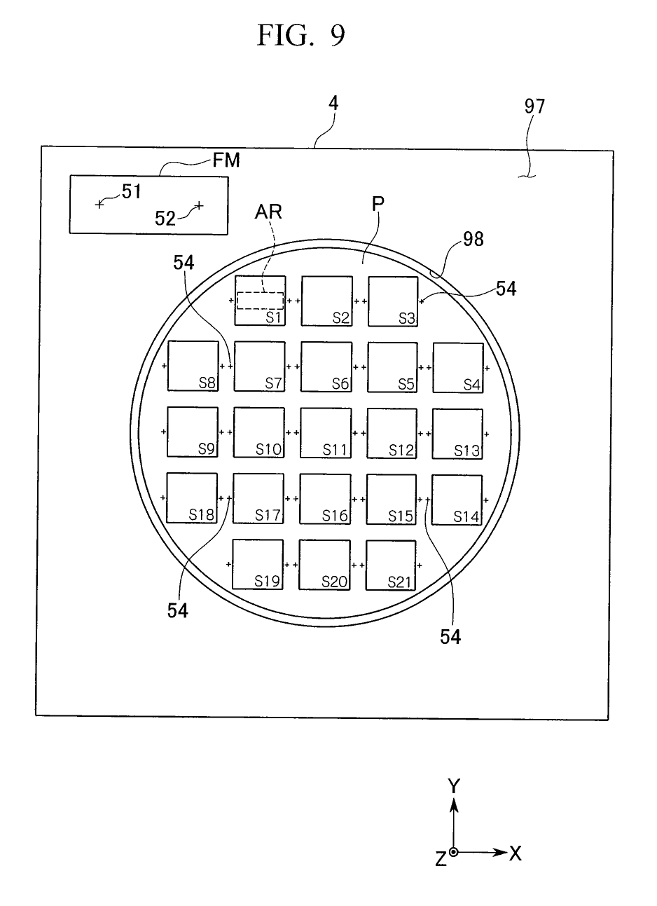

FIG. 9 is a plan view of the substrate stage 4 seen from above in which the substrate P is held in the substrate holder 4H. As shown in FIG. 9, on the substrate P, there are established a plurality of shot regions S1 to S21 of matrix shape. Furthermore, on the substrate P, there are formed alignment marks that accompany the respective shot regions S1 to S21. The control apparatus 7 monitors the position information of the substrate stage 4 by means of the laser interferometer 94 and performs, for example, positional measurement of a part of the alignment marks 54 on the substrate P by means of the alignment system 50 while moving the substrate stage 4 in the XY direction, to thereby determine the position coordinates (array coordinates) of the respective shot regions S1 to S21 provided on the substrate P.

As described above, the optical member 53 is provided at a position in the alignment system 50 that allows contact with the film of the liquid LQ on the substrate P. In the present embodiment, when measuring the alignment marks 54 on the substrate P via the liquid LQ by means of the alignment system 50 in order to perform the alignment process, the control apparatus 7 measures the alignment marks 54 in a state with the optical member 53 provided in the alignment system 50 being in contact with the film of the liquid LQ on the substrate P.

Furthermore, before or after the measurement of the alignment marks 54 on the substrate P is performed, a baseline measurement of the alignment system 50 is performed. As shown in FIG. 9, on the substrate stage 4, there is provided a reference mark plate FM that has a first and second reference marks 51 and 52. The control apparatus 7 detects the first reference mark 51 on the reference mark plate FM and the corresponding mask alignment mark on the mask M by use of the aforementioned mask alignment system 40, to thereby measure the positional relationship between the first reference mark 51 and the corresponding mask alignment mark. Moreover, the control apparatus 7 detects the second reference mark 52 on the reference mark plate FM by use of the alignment system 50, to thereby measure the positional relationship between the detection reference position of the alignment system 50 and the second reference mark 52. The control apparatus 7 then acquires the distance (positional relationship) between the projection center of the mask pattern by the projection optical system PL and the detection reference position of the alignment system 50 (i.e., the baseline information of the alignment system 50), based on the positional relationship between the first reference mark 51 and the corresponding mask alignment mark, on the positional relationship between the detection reference position of the alignment system 50 and the second reference mark 52, and on the known positional relationship between the first reference mark 51 and the second reference mark 52.

Here, when the first and second reference marks 51 and 52 on the reference mark plate FM are measured via the liquid LQ, a film of the liquid LQ is formed on the reference mark FM. For example, if a film formation apparatus that is capable of forming a film of the liquid LQ is provided in the vicinity of the reference mark plate FM, a film of the liquid LQ can be formed on the reference mark plate FM by use of the film formation apparatus. The alignment system 50 brings the film of the liquid LQ formed on the reference mark plate FM into contact with the optical member 53 to measure the second reference mark 52 via the optical member 53 and the liquid LQ. Similarly, the mask alignment system 40 brings the film of the liquid LQ formed on the reference mark plate FM into contact with the final optical element LS1 of the projection optical system PL to measure the first reference mark 51 via the projection optical system PL and the liquid LQ.

In the baseline measurement, the detection of the first reference mark 51 by the mask alignment system 40 and the detection of the second reference mark 52 by the alignment system 50 may be performed simultaneously. Alternatively, after either one of the detection of the first reference mark 51 by the mask alignment system 40 and the detection of the second reference mark 52 by the alignment system 50 is performed, the other may be performed. Especially in the latter case, the mask alignment system 40 and the alignment system 50 may detect the same reference mark on the reference mark plate FM. That is, in the baseline measurement of the alignment system 50, only one reference mark may be used.

Based on the position coordinates of the shot regions S1 to S21 obtained as a result of the aforementioned detection of the alignment marks 54 on the substrate P and on the baseline information previously measured, the control apparatus 7 sequentially exposes the pattern image of the mask M onto the shot regions S1 to S21 on the substrate P while aligning the respective shot regions S1 to S21 with the mask M (projection region AR) (Step SA4).

The exposure apparatus EX of the present embodiment is a scanning type exposure apparatus (a so called scanning stepper) which exposes the pattern formed on the mask M onto the substrate P while the mask M and the substrate P are synchronously moved in a predetermined scanning direction (for example the Y axis direction). The control apparatus 7, while measuring the position information of the mask M (mask stage 3) and the substrate P (the substrate stage 4) by means of the laser interferometers 92 and 94, moves the mask M and the substrate P with respect to the exposure light EL, and sequentially exposes the individual shot regions S1 to S21. The control apparatus 7, on completion of exposure of one shot region, stepwise moves the substrate P (substrate stage 4), and moves the next shot region to the exposure commencement position, and thereafter moves the substrate P by a step and scan method, to sequentially scan and expose the respective shot regions S1 to S21. The control apparatus 7 sequentially exposes the respective shot regions S1 to S21 on the substrate P in the state with the bottom surface LK of the final optical element LS1 being in contact with the film of the liquid LQ on the substrate P. There is no gas portion between the final optical element LS1 and the liquid LQ. Therefore, the exposure light EL can favorably reach the substrate P.

The control apparatus 7 exposes the substrate P while using the focus leveling detection system 30 to measure the surface position information of the substrate P. The control apparatus 7 controls the position of the substrate P held in the substrate stage 4 (substrate holder 4H) by way of a substrate stage driving unit 6 based on the detection results of the focus leveling detection system 30. Thus, while adjusting the positional relationship between the surface of the substrate P and the image plane formed via the projection optical system PL as well as the liquid LQ, the control apparatus 7 exposes the substrate P. As described above, when the focus leveling detection system 30 is used to detect the surface position information of the substrate P, the optical members 33 of the focus leveling detection system 30 are brought into contact with the film of the liquid LQ. The focus leveling detection system 30 irradiates the detection light La onto the surface of the substrate P in the state with the optical members 33 being in contact with the liquid LQ. Therefore, the surface information of the substrate P can be detected with a suitable degree of accuracy.

In the present embodiment, in order to keep the condition of the film of the liquid LQ on the substrate P (in order to prevent the liquid LQ from disappearing from the surface of the substrate P) even when the substrate P is exposed while being moved, movement conditions of the substrate P (substrate stage 4), film formation conditions of the liquid LQ, and the like are optimized. Here, the movement conditions of the substrate P include: the movement speed, acceleration, deceleration, movement direction, and movement trajectory of the substrate P; the movement distance when the substrate P is moved in a predetermined direction; and the distance between the surface of the substrate P and the bottom surface LK of the final optical element LS1 as well as the bottom surfaces 33K of the optical members 33 when the substrate P is moved. The film formation conditions (spread conditions) of the liquid LQ include the film thickness of the liquid LQ. In the present embodiment, the film thickness of the liquid LQ formed on the substrate P is set to 5 mm or less. As a result, leakage of the liquid LQ from the surface of the substrate P can be suppressed. Furthermore, there is a possibility that the quantity of the exposure light EL and the detection light La is decreased after the lights have passed through the liquid LQ. However, the film thickness of the liquid LQ equal to or less than a predetermined value (5 mm or less) enables the exposure light EL and the detection light La to reach the substrate P with a desired quantity of light. When the substrate P is moved with respect to the final optical element LS1 and the optical members 33 in order to expose the substrate P, the substrate P may be moved while the contact and spacing-off between the film of the liquid LQ on the substrate P and the final optical element LS1 as well as the optical members 33 are repeated.

After completion of the exposure of the substrate P, the control apparatus 7 uses the transfer apparatus 81 (or another transfer apparatus) to carry out the substrate P onto which the exposure light EL has been irradiated, together with the liquid LQ on the substrate P (Step SA5). The substrate P that has been carried out from the substrate holder 4H is removed of the film of the liquid LQ, and is then subjected to predetermined process(es) such as a development process. The recovery mechanism 83 is provided along the transfer pathway of the transfer system including the transfer apparatus 81. Therefore, even if the liquid LQ is flowed out from the surface of the substrate P, the leaked liquid LQ can be recovered by the recovery mechanism 83. When the substrate P after exposure is carried out from the substrate holder 4H, a transfer apparatus different from the transfer apparatus 81 may be used.

As described above, forming a film of the liquid LQ on the surface of the substrate P in advance before the substrate P is held in the substrate holder 4H allows the substrate P held in the substrate holder 4H to be immersion exposed without a supply operation and recovery operation of the liquid LQ at the exposure process position EP. When a liquid LQ with a high viscosity is used as in the present embodiment, it is very likely to be difficult to recover the liquid LQ from the surface of the substrate P Other than the viscosity of the liquid LQ, depending on a variety of material characteristics such as the surface tension of the liquid LQ and the affinity (wet characteristics) of the liquid LQ to the surface of the substrate P, there is a possibility that it is difficult to recover the liquid LQ from the surface of the substrate P. In the configuration in which a supply operation of a liquid is performed in parallel with a recovery operation thereof to form a liquid immersion region of the liquid on the substrate P, there arises a situation in which regions with the liquid LQ and regions without the liquid LQ are present on the substrate P if the liquid LQ is left on the substrate P as a result of insufficient recovery of the liquid LQ from the surface of the substrate P. In that case, it follows that the regions with the liquid LQ and the regions without the liquid LQ are different in the exposure condition and/or the measurement condition. Therefore, there is a possibility that the pattern image of the mask M cannot be favorably exposed onto the substrate P, or that the respective measurement processes using the focus leveling detection system 30 or the like cannot be favorably performed. In the present embodiment, a film of the liquid LQ is pre-formed over substantially the entire region of the surface of the substrate P, and the exposure process and the measurement process are performed without performing a recovery process of the liquid LQ. Therefore, the exposure process and the measurement process can be performed with good accuracy.

Furthermore, a transfer apparatus 81 is provided that is capable of carrying in the substrate P on which the film of the liquid LQ is formed to the substrate holder 4H. Therefore, after the film of the liquid LQ is favorably formed on the substrate P by use of the film formation apparatus 60 provided at a position different from that of the substrate holder 4H (substrate stage 4), the substrate P can be carried in to the substrate holder 4H to be favorably immersion exposed. That is, in the case where a film of the liquid LQ is intended to be formed on the substrate P at the exposure process position EP, there is a possibility that a film of the liquid LQ cannot be favorably formed on the substrate P depending on the characteristics of the liquid LQ. Again, in the case where a film of the liquid LQ is intended to be formed on the substrate P at the exposure process position EP, there is a possibility that there arises a necessity to provide a film formation apparatus in the vicinity of the projection optical system PL or the substrate stage 4, to thus decrease a degree of freedom of drive for the individual driving units of the substrate stage 4 and the like, or to decrease a degree of freedom of arrangement for the peripheral apparatuses. In the present embodiment, the dedicated film formation apparatus 60 for forming a film of the liquid LQ on the substrate P is provided at a position different from that of the substrate holder 4H (substrate stage 4). Therefore, a film of the liquid LQ can be smoothly formed on the substrate P while the characteristics of the liquid LQ are flexibly addressed.

Furthermore, the substrate P that has been irradiated with the exposure light EL is carried out from the substrate holder 4H together with the liquid LQ by the transfer apparatus 81 (or another transfer apparatus). Therefore, after the carry-out of the substrate P from the substrate holder 4H, the film of the liquid LQ on the substrate P can be favorably removed by use of a predetermined apparatus that is capable of removing the film of the liquid LQ on the substrate P. Note that this apparatus for removing the film of the liquid LQ may be provided within the exposure apparatus EX, in the coater/developer apparatus, or in the interface between the two apparatuses.

Then, the focus leveling detection system 30 can use the detection light La to detect the surface position information of the substrate P with a suitable degree of accuracy in a state with the film of the liquid LQ formed on the surface of the substrate P being in contact with the optical members 33. Furthermore, the focus leveling detection system 30 irradiates the detection light La outside the irradiation region AR on the substrate P onto which the exposure light EL is irradiated. Therefore, it can smoothly irradiate the detection light La to detect the surface position information of the substrate P with a suitable degree of accuracy.

### Second Embodiment

Next is a description of a second embodiment. In the following description, components the same as or similar to those of the abovementioned embodiment are denoted by the same reference symbols, and descriptions thereof are simplified or omitted.

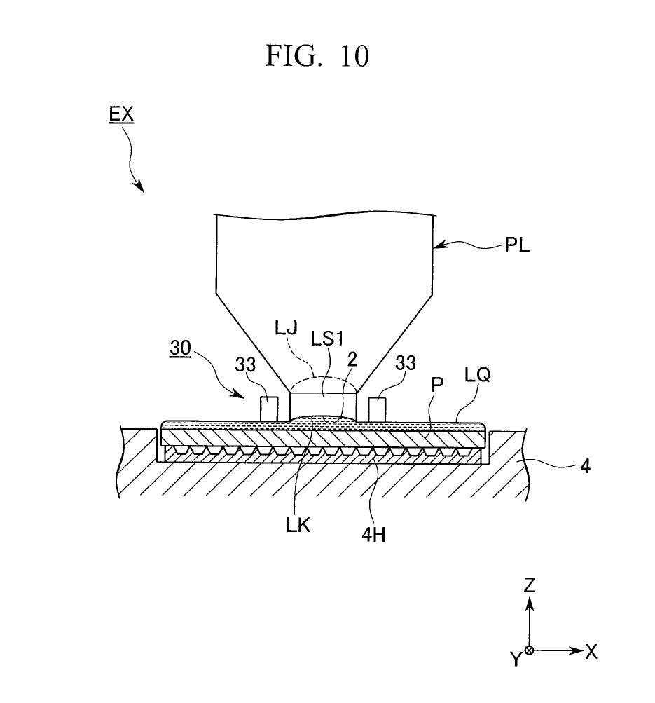

FIG. 10 shows an exposure apparatus EX according to the second embodiment. In FIG. 10, the bottom surface LK of the final optical element LS1 of the projection optical system PL has a concave surface region 2 which is formed so as to face a substrate P. A film of the liquid LQ formed on the substrate P contacts the bottom surface LK including the concave surface region 2 of the final optical element LS1. The concave surface region 2 of the bottom surface LK is of curved shape. Note that the shapes of the upper surface LJ and bottom surface of the final optical element LS1 are appropriately established so that the projection optical system PL can obtain desired performance. For example, the bottom surface LK of the final optical element LS1 may be of spherical shape or aspherical shape. Moreover, the upper surface LJ of the final optical element LS1 may be of spherical shape or aspherical shape.

In the case where the projection optical system PL has a numerical aperture (NA), which is at the image plane side of the projection optical system PL, lower than the refractive index of the liquid LQ, for example, when the final optical element LS1 is made of an optical material with a high refractive index, one or both of the bottom surface LK and upper surface LJ of the final optical element LS1 may be flat.

In the present embodiment, a liquid LQ with a refractive index (for example, glycerol or the like) is used as in the above first embodiment. Therefore, the numerical aperture on the image plane side of the projection optical system PL can be high. Additionally, the concave surface region 2 is provided in the bottom surface LK of the final optical element LS1. Therefore, even in the case where the numerical aperture on the image plane side of the projection optical system PL is higher than the refractive index of the final optical element LS1, the exposure light EL can favorably reach the image plane side of the projection optical system PL.

In the case where the film of the liquid LQ formed on the substrate P is brought into contact with the bottom surface LK of the final optical element LS1, as described with reference to FIG. 8, the control apparatus 7, after carrying in the substrate P to the substrate holder 4H on the substrate stage 4 at the substrate exchange position RP, moves the substrate stage 4 from the substrate exchange position RP to the exposure process position EP while preventing the final optical element LS1 and the optical members 33 from contacting the film of the liquid LQ on the substrate P held in the substrate holder 4H, and then moves the substrate stage 4 upward, to thereby bring the final optical element LS1 into contact with the film of the liquid LQ on the substrate P held in the substrate holder 4H. As a result, the liquid LQ on the substrate P can find its way into the concave surface region 2 in the bottom surface LK of the final optical element LS1, to thereby bring the bottom surface LK of the final optical element LS1 into contact with the liquid LQ.

In the above first and second embodiments, as described with reference to FIG. 8, the control apparatus 7, after carrying in the substrate P to the substrate holder 4H on the substrate stage 4 at the substrate exchange position RP, moves the substrate stage 4 from the substrate exchange position RP to the exposure process position EP while preventing the final optical element LS1 and the optical members 33 from contacting the film of the liquid LQ on the substrate P held in the substrate holder 4H, and then moves the substrate stage 4 upward, to thereby bring the final optical element LS1 into contact with the film of the liquid LQ on the substrate P held in the substrate holder 4H. However, for example, somewhere along the movement pathway of the substrate stage 4, which position is different from the substrate exchange position RP, the substrate stage 4 may be moved from the substrate exchange position RP to the exposure process position EP while the film of the liquid LQ contacts the final optical element LS1 and/or the optical members 33. Alternatively, the substrate stage 4 may be moved from the substrate exchange position RP to the exposure process position EP while the contact and spacing-off between the film of the liquid LQ on the substrate P and the final optical element LS1 as well as the optical members 33 are repeated.

In the above first and second embodiments, the exposure light EL is irradiated onto the substrate P while the surface position information of the substrate P is detected by means of the focus leveling detection system 30. However, before exposure of the substrate P, the surface position information of the substrate P held in the substrate holder 4H may be measured in advance by means of the focus leveling detection system 30, and then the substrate P may be exposed while the position of the substrate P is controlled in the Z axis direction, the θX direction, and the θY direction based on the measurement result. To be more specific, before exposing the substrate P, the control apparatus 7 uses the focus leveling detection system 30 to detect the surface position information of the substrate P held in the substrate holder 4H via the liquid LQ while measuring the position information of the substrate stage 4 in the XY direction by means of the laser interferometer 94, and then stores the detection results. Subsequently, based on the stored information (the surface position information of the substrate P), the control apparatus 7 exposes the substrate P via the liquid LQ while controlling the position of the substrate P in the Z axis direction, the θX direction, and the θY direction. In this case, the focus leveling detection system 30 (the optical members 33) may be provided spaced apart from the projection optical system PL, or a plurality of pairs of the projection system 31 and the light receiving system 32 may be used for a single optical member 33.

The surface position information of the substrate P may be obtained by use of the focus leveling detection system 30 at a position spaced apart from the projection optical system PL in the state with the projection optical system PL not in contact with the liquid LQ. In this case, the surface position information of the substrate P may be obtained before the film of the liquid LQ is formed on the substrate P.

### Third Embodiment

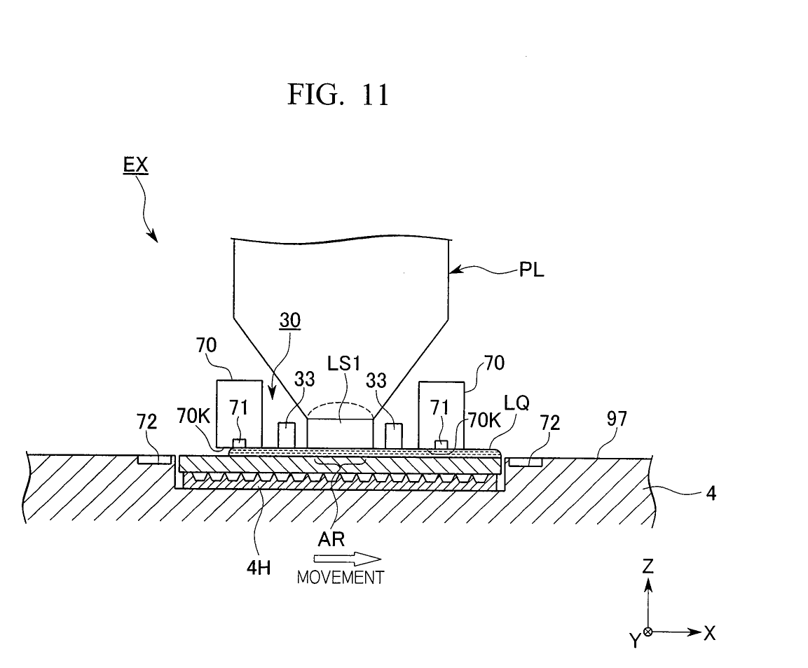

Next is a description of a third embodiment. In the following description, components the same as or similar to those of the abovementioned embodiments are denoted by the same reference symbols, and description thereof is simplified or omitted. FIG. 11 is a diagram for explaining an exposure apparatus EX according to the third embodiment. In FIG. 11, in the vicinity of the front end of the projection optical system PL, there is provided a nozzle member 70 that has a supply port 71 capable of supplying the liquid LQ onto the substrate P. The nozzle member 70 is provided further away than the optical members 33 with respect to the optical path space (the projection region AR) of the exposure light EL. The supply port 71 is provided in a bottom surface 70K of the nozzle member 70 that faces the surface of the substrate P held in the substrate holder 4H.

In the present embodiment, the substrate P on which the film of the liquid LQ is not formed is carried in to the substrate holder 4H. The control apparatus 7 supplies the liquid LQ onto the substrate P held in the substrate holder 4H from the nozzle member 70 provided above the substrate P (substrate stage 4), to thereby form a film of the liquid LQ on the substrate P. That is, the exposure apparatus EX of the present embodiment has a film formation apparatus that includes a nozzle member 70 for forming a film of the liquid LQ onto the substrate P after the substrate P is held in the substrate holder 4H.

When the film of the liquid LQ is formed on the substrate P with the liquid LQ supplied from the supply port 71 of the nozzle member 70, the control apparatus 7 supplies the liquid LQ onto the substrate P from the supply port 71 of the nozzle member 70 while moving the substrate stage 4 holding the substrate P in the XY direction. The film formation apparatus of the present embodiment has a nozzle member 70 capable of supplying the liquid LQ onto the substrate P from above the substrate P. Therefore, the film of the liquid LQ can be smoothly formed on the substrate P, with a simple configuration, without decreasing the degree of freedom of drive for the substrate stage 4 and the like.

Furthermore, on an upper surface 97 of the substrate stage 4, there is formed a recovery port (recovery mechanism) 72 for recovering the liquid LQ so as to surround the substrate P held in the substrate holder 4H. Even if the liquid LQ flows out from the surface of the substrate P, the leaked liquid LQ is recovered in the recovery port 72.

Next is a description of a method for exposing the substrate P by use of an exposure apparatus EX with the aforementioned configuration. First, the substrate P is carried in to the substrate holder 4H (substrate stage 4). As described above, in the present embodiment, a film of the liquid LQ is not formed on the substrate P carried in to the substrate holder 4H. After the substrate P is carried in to the substrate holder 4H, the control apparatus 7 supplies the liquid LQ onto the substrate P from the supply port 71 of the nozzle member 70 while moving the substrate stage 4 in the XY direction, to thereby form a film of the liquid LQ on the substrate P. In the present embodiment, the control apparatus 7 forms a film of the liquid LQ over substantially the entire region of the surface of the substrate P with the liquid LQ supplied from the supply port 71 of the nozzle member 70.

After forming the film of the liquid LQ on the substrate P, the control apparatus 7 uses the alignment system 50 to measure the alignment marks 54 on the substrate P via the liquid LQ, as is the case with the above embodiments. The control apparatus 7 monitors the position information of the substrate stage 4 by means of the laser interferometer 94 and performs positional measurement of the alignment marks 54 on the substrate P by means of the alignment system 50 while moving the substrate stage 4 in the XY direction, to thereby determine the position coordinates (array coordinates) of the respective shot regions S1 to S21 provided on the substrate P.

Based on the position coordinates of the shot regions S1 to S21 obtained as a result of the aforementioned detection of the alignment marks 54 on the substrate P and on the baseline information previously measured, the control apparatus 7 sequentially exposes the pattern image of the mask M onto the shot regions S1 to S21 on the substrate P while aligning the respective shot regions S1 to S21 on the substrate P with the mask M (projection region AR). The control apparatus 7 exposes the substrate P while using the focus leveling detection system 30 to measure the surface position information of the substrate P via the liquid LQ.

After completion of the exposure of the substrate P, the control apparatus 7 uses the transfer apparatus 81 (or another transfer apparatus) to carry out the substrate P onto which the exposure light EL has been irradiated, together with the liquid LQ on the substrate P.

In the third embodiment, after using the nozzle member 70 to form the film of the liquid LQ over substantially the entire region of the surface of the substrate P, the control apparatus 7 may use the focus leveling detection system 30, before exposing the substrate P, to detect the surface position information of the substrate P held in the substrate holder 4H via the liquid LQ while measuring the position information of the substrate stage 4 in the XY direction, to thereby store the detection results, and then may expose the substrate P via the liquid LQ while controlling the position of the substrate P in the Z axis direction, the θX direction, and the θY direction based on the stored information.

In the third embodiment, the alignment system 50 is used to detect the alignment marks 54 on the substrate P via the liquid LQ after the nozzle member 70 is used to form the film of the liquid LQ on the substrate P. However, after the substrate P on which the film of the liquid LQ is not formed is carried in to the substrate holder 4H, the alignment system 50 may be used to detect the alignment marks 54 on the substrate P not via the liquid LQ before formation of the film of the liquid LQ by use of the nozzle member 70. In this case, when the alignment system 50 is used to obtain the baseline information for measuring the second reference mark 52 on the reference mark plate FM, a measurement operation of the second reference mark 52 is performed by the alignment system 50 not via the liquid LQ. That is, when the alignment system 50 is used to measure the second reference mark 52 on the reference mark plate FM, a film of the liquid LQ is not formed on the second reference mark 52. The control apparatus 7 can align the shot regions S1 to S21 on the substrate P with the mask M (projection region AR) based on the baseline information and on the position information of the alignment marks 54 on the substrate P measured by the alignment system 50 not via the liquid LQ. After completion of the measurement operation by the alignment system 50, the control apparatus 7 uses the nozzle member 70 to form a film of the liquid LQ on the substrate P and exposes the substrate P via the liquid LQ. When exposing the substrate P after the formation of the film of the liquid LQ on the substrate P by use of the nozzle member 70, the surface position information of the substrate P may be detected via the liquid LQ by means of the focus leveling detection system 30 and the exposure light EL may be irradiated onto the substrate P while the position of the substrate P is controlled based on the detection results. Alternatively, the focus leveling detection system 30 may be used to detect the surface position information of the substrate P via the liquid LQ before the exposure light EL is irradiated onto the substrate P, to thereby store the detection results, and then the exposure light EL may be irradiated onto the substrate P while the position of the substrate P is controlled based on the stored information.

In the third embodiment, the exposure light EL is irradiated onto the substrate P after the nozzle member 70 is used to form a film of the liquid LQ on the surface of the substrate P. However, the detection of the surface position information of the substrate P by the focus leveling detection system 30 and the exposure of the substrate P may be performed while the liquid LQ is supplied from the nozzle member 70. For example, as shown in FIG. 11, by supplying the liquid LQ onto the substrate P from the supply port 71 of the nozzle member 70 provided on the —X side with respect to the optical path space (the projection region AR) of the exposure light EL while moving the substrate P (the substrate stage 4) in the +X direction, irradiation of the detection light La of the focus leveling detection system 30 and irradiation of the exposure light EL can be performed while filling the space between the substrate P and the optical members 33 and the space between the substrate P and the final optical element LS1 with the liquid LQ. In this case, after the alignment system 50 is used to measure the alignment marks 54 on the substrate P and the second reference mark 52 on the reference mark plate FM not via the liquid LQ, detection of the surface position information of the substrate P by the focus leveling detection system 30 and exposure of the substrate P are performed while the liquid LQ is supplied from the nozzle member 70.

Alternatively, in the third embodiment, before supplying the liquid LQ onto the substrate P from the nozzle member 70, the alignment system 50 may be used to measure the alignment marks 54 on the substrate P and the second reference mark 52 on the reference mark plate FM, and the focus leveling detection system 30 may be used to detect the surface position information of the substrate P not via the liquid LQ. In this case, the surface position information of the substrate P detected by the focus leveling detection system 30 not via the liquid LQ is stored in the control apparatus 7. After that, the control apparatus 7 uses the nozzle member 70 to form a film of the liquid LQ on the surface of the substrate P, and exposes the substrate P via the liquid LQ while controlling the position of the substrate P based on the stored surface position information of the substrate P. When the substrate P is exposed, the exposure light EL may be irradiated onto the substrate P after the nozzle member 70 is used to form the film of the liquid LQ over substantially the entire region of the surface of the substrate P, or the exposure light EL may be irradiated onto the substrate P while the liquid LQ is supplied onto the substrate P from the nozzle member 70.

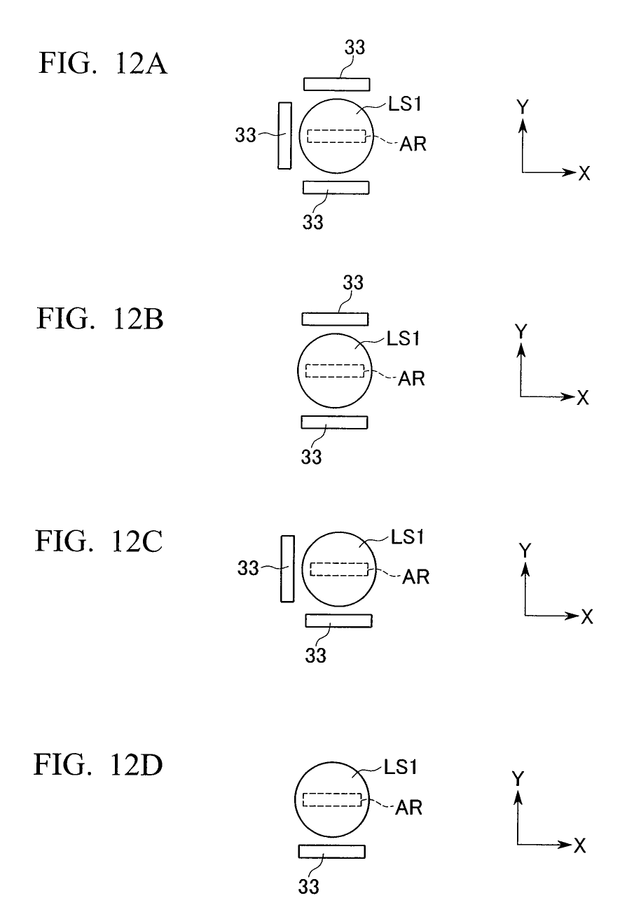

In the above first to third embodiments, the optical members 33 of the focus leveling detection system 30 are described as being four optical members provided so as to surround the final optical element LS1. However, their arrangement is optionally established. For example, as shown in FIG. 12A, the optical members 33 may be arranged on the —X side, +Y side, and —Y side of the final optical element LS1. As shown in FIG. 12 B, they may be arranged on the +Y side and —Y side of the final optical element LS1. As shown in FIG. 12C, they may be arranged respectively on the —X side and —Y side of the final optical element LS1. As show in FIG. 12D, one optical member 33 may be provided only on the —Y side of the final optical element LS1.

Moreover, in the above embodiments, a film of the liquid LQ is formed over the entire surface of the substrate P. However, the invention is not limited to this, and, for example, the film of the liquid LQ may be formed so as to cover only the region to be exposure processed and/or measurement processed.

In the above embodiments, examples of the liquid LQ for forming a film on the substrate P include for example: a predetermined liquid such as isopropanol, hexane, heptane, and decane. Alternatively, this may be a liquid where two or more types of optional liquids of predetermined liquids are mixed. Alternatively, pure water may be used as the liquid LQ. Alternatively, a liquid in which a predetermined liquid is added to (mixed with) pure water may be used. Alternatively, one in which an acid or a base such as H⁺, Cs⁺, and K⁺, or Cl⁻, SO₄²⁻, and PO₄²⁻ is added to (mixed with) pure water may be used. Moreover, one in which fine particles of for example Al oxide are added to (mixed with) pure water may be used. These liquids LQ are capable of passing the ArF excimer laser light.

In the above embodiments, the ArF excimer laser light is used as the exposure light EL. However, as described above, various exposure lights (exposure beams) such as the F₂ laser light may be adopted. For the liquid LQ, the optimal one may be appropriately used depending on the exposure light (exposure beam) EL, the numerical aperture of the projection optical system PL, the refractive index of the final optical element LS1, and the like. For example, if the light source of the exposure light EL is an F₂ laser, the liquid LQ may be, for example, a fluorocarbon fluid such as a perfluoropolyether (PFPE) or a fluorocarbon oil that an F₂ laser is able to pass through.

In the above embodiments, the description has been made referring to, as a measurement apparatus that has optical members to be contacted with the film of the liquid LQ on the substrate P, the focus leveling detection system 30 and the alignment system 50 by way of example. However, any measurement apparatus may be used as long as it is a measurement apparatus that performs measurement related to an exposure process.

In the above embodiments, the exposure apparatus EX has a film formation apparatus for forming a film of the liquid LQ on the substrate P. However, a film formation apparatus for forming a film of the liquid LQ on the substrate P may be provided separately from the exposure apparatus EX. In this case, the exposure apparatus EX is capable of using the transfer apparatus 81 to carry in the substrate P, on which a film of the liquid LQ is formed by a film formation apparatus different from the exposure apparatus EX, to the substrate holder 4H (substrate stage 4).

In the above embodiments, the projection optical system PL has the optical path space on the image plane side of the optical element at the front end (LS1) filled with a liquid. However, a projection optical system, as disclosed for example in PCT International Publication No. WO 2004/019128, in which the optical path space on the object plane side of the optical element at the front end is also filled with a liquid, may be adopted.

In the abovementioned embodiments, position information for each of the mask stage 3 and the substrate stage 4 is measured using an interferometer system (92, 94). However, the invention is not limited to this and for example, an encoder system which detects a scale (grating) provided in each stage may be used. In this case, preferably a hybrid system is furnished with both of an interference system and an encoder system, and calibration of the measurement results of the encoder system is performed using the measurement results of the interference system. Moreover, position control of the stage may be performed using the interference system and the encoder system interchangeably, or using both.

It is to be noted that as for the substrate P of the above embodiments, not only a semiconductor wafer for manufacturing a semiconductor device, but also a glass substrate for a display device, a ceramic wafer for a thin film magnetic head, or a master mask or reticle (synthetic quartz or silicon wafer) for use in an exposure apparatus, etc. can be used.

As for exposure apparatus EX, in addition to a scan type exposure apparatus (scanning stepper) in which while synchronously moving the mask M and the substrate P, the pattern of the mask M is scan-exposed, a step-and-repeat type projection exposure apparatus (stepper) in which the pattern of the mask M is exposed at one time in the condition that the mask M and the substrate P are stationary, and the substrate P is successively moved stepwise can be used.

Moreover, as for the exposure apparatus EX, the present invention can be applied to an exposure apparatus of a method in which a reduced image of a first pattern is exposed in a batch on the substrate P by using the projection optical system (for example, a refractive projection optical system having, for example, a reduction magnification of ⅛, which does not include a reflecting element), in the state with the first pattern and the substrate P being substantially stationary. In this case, the present invention can also be applied to a stitch type batch exposure apparatus in which after the reduced image of the first pattern is exposed in a batch, a reduced image of a second pattern is exposed in a batch on the substrate P, partially overlapped on the first pattern by using the projection optical system, in the state with the second pattern and the substrate P being substantially stationary. As the stitch type exposure apparatus, a step-and-stitch type exposure apparatus in which at least two patterns are transferred onto the substrate P in a partially overlapping manner, and the substrate P is sequentially moved can be used.

Moreover, in the above embodiment, an exposure apparatus furnished with a projection optical system PL was described as an example. However, the present invention can also be applied to an exposure apparatus and an exposure method which does not use a projection optical system PL. Even in the case where a projection optical system is not used, the exposure light can be irradiated onto the substrate via optical members such as a mask and lens, and an immersion region can be formed in a predetermined space between these optical elements and the substrate.

Furthermore, the present invention can also be applied to a twin stage type exposure apparatus furnished with a plurality of substrate stages, as disclosed for example in Japanese Unexamined Patent Application, First Publication No. H10-163099, Japanese Unexamined Patent Application, First Publication No. H10-214783 (corresponding to U.S. Pat. No. 6,590,634), Published Japanese Translation No. 2000-505958 of PCT International Application (corresponding to U.S. Pat. No. 5,969,441), and U.S. Pat. No. 6,208,407.

Moreover, the present invention can also be applied to an exposure apparatus furnished with a substrate stage for holding a substrate, and a measurement stage on which are mounted a reference member formed with a reference mark and various photoelectronic sensors, as disclosed for example in Japanese Unexamined Patent Application, First Publication No. H11-135400 (corresponding to PCT International Patent Publication No. WO 1999/23692), and Japanese Unexamined Patent Application, First Publication No. 2000-164504 (corresponding to U.S. Pat. No. 6,897,963).

The types of exposure apparatuses EX are not limited to exposure apparatuses for semiconductor element manufacture that expose a semiconductor element pattern onto a substrate P, but are also widely applicable to exposure apparatuses for the manufacture of liquid crystal display elements and for the manufacture of displays, and exposure apparatuses for the manufacture of thin film magnetic heads, image pickup devices (CCDs), micro machines, MEMS, DNA chips, and reticles or masks.

In the above embodiments, an optical transmission type mask formed with a predetermined shielding pattern (or phase pattern or dimming pattern) on an optical transmission substrate is used. However instead of this mask, for example as disclosed in U.S. Pat. No. 6,778,257, an electronic mask (called a variable form mask including, for example, a DMD (Digital Micro-mirror Device) as one type of non-radiative type image display element) for forming a transmission pattern or reflection pattern, or a light emitting pattern, based on electronic data of a pattern to be exposed may be used.

Furthermore the present invention can also be applied to an exposure apparatus (lithography system) which exposes a line-and-space pattern on a substrate P by forming interference fringes on the substrate P, as disclosed for example in PCT International Patent Publication No. WO 2001/035168.

Moreover, the present invention can also be applied to an exposure apparatus as disclosed for example in Published Japanese Translation No. 2004-519850 of PCT International Application (corresponding to U.S. Pat. No. 6,611,316), which combines patterns of two masks on a substrate via a projection optical system, and double exposes a single shot region on the substrate at substantially the same time, using a single scan exposure light.

As far as is permitted by the law of the countries specified or selected in this patent application, the disclosures in all of the Japanese Patent Publications and U.S. patents related to exposure apparatuses and the like cited in the above respective embodiments and modified examples, are incorporated herein by reference.

As described above, the exposure apparatus EX of the embodiments of this application is manufactured by assembling various subsystems, including each constituent elements presented in the Scope of Patent Claims of the present application, so that the prescribed mechanical precision, electrical precision and optical precision can be maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes mechanical connections, electrical circuit wiring connections, air pressure circuit piping connections, etc. among the various subsystems. Obviously, before the process of assembly from these various subsystems to the exposure apparatus, there are the processes of individual assembly of the respective subsystems. When the process of assembly to the exposure apparatuses of the various subsystems has ended, overall assembly is performed, and the various precisions are ensured for the exposure apparatus as a whole. Note that it is preferable that the manufacture of the exposure apparatus be performed in a clean room in which the temperature, the degree of cleanliness, etc. are controlled.

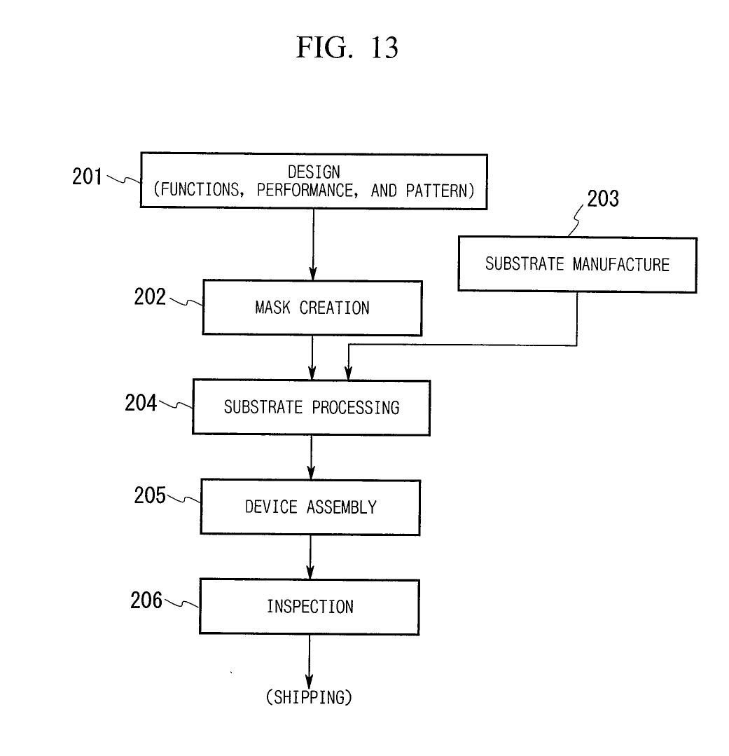

As shown in FIG. 13, microdevices such as semiconductor devices are manufactured by going through; a step 201 that performs microdevice function and performance design, a step 202 that creates the mask (reticle) based on this design step, a step 203 that manufactures the substrate that is the device base material, a step 204 including substrate processing steps such as a process that exposes the pattern on the mask onto a substrate by means of the exposure apparatus EX of the aforementioned embodiments, a process for developing the exposed substrate, and a process for heating (curing) and etching the developed substrate, a device assembly step (including treatment processes such as a dicing process, a bonding process and a packaging process) 205, and an inspection step 206, and so on.

### INDUSTRIAL APPLICABILITY

According to the present invention, in a liquid immersion exposure apparatus, the position information of the substrate can be smoothly measured and the exposure process can be performed with a suitable degree of accuracy. Therefore, the present invention is extremely useful in an exposure method and apparatus for manufacturing a wide range of products such as for example: semiconductor elements, liquid crystal display elements or displays, thin film magnetic heads, CCDs, micro machines, MEMS, DNA chips, and reticles (masks).

1. An exposure apparatus that exposes a substrate via a liquid, comprising:
a substrate holding member that holds a substrate onto which exposure light is irradiated; and
a film formation apparatus that forms a film of the liquid on the substrate before the substrate is held in the substrate holding member.

2. The exposure apparatus according to claim 1, further comprising
a first transfer apparatus that carries in the substrate on which the film of the liquid is formed by the film formation apparatus to the substrate holding member.

3. An exposure apparatus that exposes a substrate via a liquid, comprising:
a substrate holding member that holds a substrate onto which exposure light is irradiated; and
a first transfer apparatus that carries in the substrate on which a film of the liquid has been formed or is being formed to the substrate holding member.

4. The exposure apparatus according to claim 1, further comprising
a measurement apparatus that has a first optical element to be contacted with the film of the liquid, and directs measurement light onto the substrate via the first optical element and the liquid to perform a measurement related to an exposure process, wherein
the measurement apparatus directs the measurement light outside an irradiation region, on the substrate, onto which the exposure light is irradiated.

5. An exposure apparatus that exposes a substrate via a liquid, comprising:
a substrate holding member that holds the substrate, on a surface of which a film of the liquid is formed; and
a measurement apparatus that has a first optical element to be contacted with the film of the liquid and directs measurement light onto the substrate via the first optical element and the liquid to perform a measurement related to an exposure process, wherein
the measurement apparatus directs the measurement light outside an irradiation region, on the substrate, onto which exposure light is irradiated.

6. The exposure apparatus according to claim 4, wherein the first optical element is arranged outside an irradiation region, on the substrate, onto which the exposure light is irradiated.

7. The exposure apparatus according to claim 4, wherein the measurement apparatus comprises a first measurement unit that measures surface position information of the substrate.

8. The exposure apparatus according to claim 4, wherein the measurement apparatus comprises a second measurement unit that measures at least one of an alignment mark on the substrate and a reference mark provided on the substrate holding member.

9. The exposure apparatus according to claim 1, further comprising a second transfer apparatus that carries out the substrate that has been irradiated with the exposure light from the substrate holding member together with the liquid on the substrate.

10. The exposure apparatus according to claim 1, further comprising a second optical element which contacts the liquid and through which the exposure light passes.

11. A device manufacturing method, comprising:
providing an exposure apparatus that exposes a substrate via a liquid, the exposure apparatus including a substrate holding member that holds a substrate onto which exposure light is irradiated, and a film formation apparatus that forms a film of the liquid on the substrate before the substrate is held in the substrate holding member; and
exposing a substrate with the exposure apparatus.

12. An exposure method for exposing a substrate via a liquid, the method comprising:
holding the substrate in a substrate holding member after a film of the liquid is formed on a surface of the substrate; and
irradiating the substrate with exposure light via the liquid.

13. The exposure method according to claim 12, wherein
the film of the liquid is formed on the substrate during transport along a transfer pathway thereof until the substrate is carried in to the substrate holding member.

14. The exposure method according to claim 12, wherein
a first optical member contacts the film of the liquid on the substrate held in the substrate holding member, and measurement light is directed onto the substrate via the first optical member and the liquid to perform a measurement related to an exposure process.

15. An exposure method for exposing a substrate via a liquid, the method comprising:
holding the substrate, on a surface of which a film of the liquid has been formed or is being formed, in a substrate holding member, and
bringing a first optical member into contact with the film of the liquid, and directing measurement light onto the substrate via the first optical member and the liquid to perform a measurement related to an exposure process.

16. The exposure method according to claim 14, wherein
the measurement light is directed at least onto a region other than an irradiation region onto which exposure light is irradiated.

17. The exposure method according to claim 14, wherein
position information of the substrate is measured with projection of the measurement light.

18. The exposure method according to claim 17, wherein
the substrate is held in the substrate holding member so that a surface thereof is substantially parallel with a predetermined surface, and the position information comprises at least one of position information on a direction perpendicular to the predetermined surface and position information within the predetermined surface.

19. The exposure method according to claim 14, wherein
the measurement light is directed onto the substrate before and/or during the exposure process.

20. The exposure method according to claim 12, wherein
the exposed substrate is carried out from the substrate holding member together with the liquid thereon.

21. The exposure method according to claim 12, wherein
in the exposure process, a second optical member contacts the film of the liquid, and measurement light is directed onto the substrate via the second optical member and the liquid.

22. A device manufacturing method comprising:
providing a substrate; and
exposing the substrate by an exposure process including holding the substrate in a substrate holding member after a film of a liquid is formed on a surface of the substrate, and irradiating the substrate with exposure light via the liquid.
